(19) United States
(12) Patent Application Publication
(10) Pub. No.: US 2022/0184730 A1
(43) Pub. Date: Jun. 16, 2022

(54) WELDING DEVICE AND METHOD FOR DETECTING WELD STATE

(71) Applicant: KABUSHIKI KAISHA TOSHIBA, Tokyo (JP)

(72) Inventors: Lisa MASUDA, Yokohama (JP); Ryuichi TOGAWA, Machida (JP)

(73) Assignee: KABUSHIKI KAISHA TOSHIBA, Tokyo (JP)

(21) Appl. No.: 17/471,349

(22) Filed: Sep. 10, 2021

(30) Foreign Application Priority Data
Dec. 11, 2020 (JP) 2020-205602

(51) Int. Cl. B23K 26/03; B23K 31/12

(52) U.S. Cl. CPC B23K 26/032; B23K 31/125

(57) ABSTRACT

A method for detecting a weld state according to an embodiment includes detecting reflected light from a portion on which a laser is irradiated and a light emission of the portion on which the laser is irradiated, and detecting a weld state of the portion on which the laser is irradiated based on the detected reflected light and the detected light emission. The detection of the weld state includes detecting whether or not a signal level of the light emission is not less than a prescribed first threshold and whether or not a signal level of the reflected light is not more than a prescribed second threshold.

### CROSS-REFERENCE TO RELATED APPLICATIONS

This application is based upon and claims the benefit of priority from the Japanese Patent Application No. 2020-205602, filed on Dec. 11, 2020; the entire contents of which are incorporated herein by reference.

### FIELD

Embodiments described herein relate generally to a welding device and a method for detecting a weld state.

### BACKGROUND

There is a welding device that welds by irradiating a laser on an object. Welding defects caused by the material of the object or the like may occur when such a welding device irradiates the laser on the object.

Welding defects include, for example, a recess that occurs at the weld zone due to molten metal scattering when laser-welding. When a recess occurs, not only is the appearance compromised, but also there is a risk that insufficient strength of the joining part may occur, or in the case of a sealing weld, leakage may occur. When a recess occurs, according to the level of the recess, a defective component may result; however, there are cases where a good part may result if the surface portion can be smoothed by re-irradiating the laser on the location at which the recess occurred and by remelting the object portion. Therefore, it is necessary to know the position and the level of the recess.

In such a case, there is a method in which the recess is detected after completing the laser welding by using the naked eye or optical observation and by re-irradiating the laser after checking the level of the recess. However, this method is problematic in that the production efficiency decreases. Also, a method has been proposed in which a light emission from the laser irradiation part that occurs when welding is measured in real time and scattering of the weld metal is detected using the intensity of the light emission; however, the level of the recess is undetermined. Also, a method has been proposed in which the reflected light from the laser irradiation part that occurs when welding is measured in real time and the recess is detected;

however, overdetection and underdetection are problematic due to the effects of the surface shape of the object at the welding position.

### BRIEF DESCRIPTION OF THE DRAWINGS

FIG. 1 is a schematic view for illustrating a welding device.

FIGS. 2A to 2C are schematic cross-sectional views for illustrating the occurrence of a recess.

FIG. 3A is a graph for illustrating the change of a signal level from a sensor detecting visible light. FIG. 3B is a graph for illustrating the change of a signal level from a sensor detecting reflected light.

FIG. 4 is an enlarged view of portion A of FIG. 3B.

FIG. 5 is a graph for illustrating the change of a signal level of visible light corresponding to the irradiation of one pulse of the laser.

FIGS. 6A to 6D are schematic views for illustrating a determination of the recess.

FIG. 7 is a schematic perspective view for illustrating a film located at the vicinity of a welding position of a workpiece.

FIG. 8 is a schematic plan view for illustrating the welding position.

FIG. 9 is a graph for illustrating the change of a signal level of visible light corresponding to the irradiation of one pulse of the laser.

FIG. 10 is a graph for illustrating spectra of light corresponding to the irradiation of one pulse of the laser.

### DETAILED DESCRIPTION

A method for detecting a weld state according to an embodiment includes a process of detecting a reflected light from a portion on which a laser is irradiated and a light emission of the portion on which the laser is irradiated, and a process of detecting a weld state of the portion on which the laser is irradiated based on the detected reflected light and the detected light emission. The process of detecting the weld state includes detecting whether or not a signal level of the light emission is not less than a prescribed first threshold and whether or not a signal level of the reflected light is not more than a prescribed second threshold.

Exemplary embodiments will now be described with reference to the drawings. Similar components in the drawings are marked with like reference numerals; and a detailed description is omitted as appropriate.

First, a welding device 1 that is configured to perform the method for detecting the weld state according to the embodiment will be described.

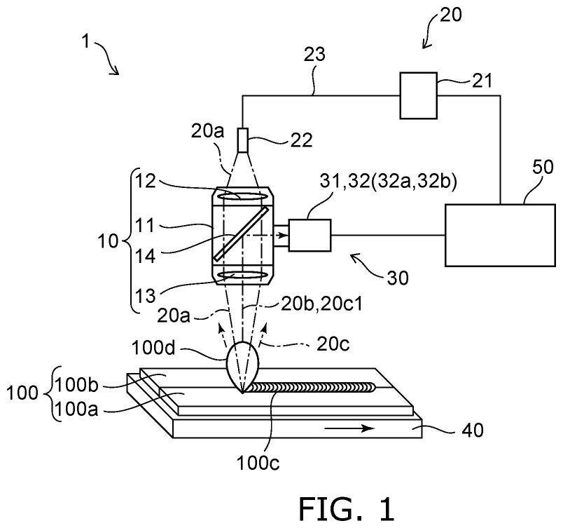

FIG. 1 is a schematic view for illustrating the welding device 1.

The welding device 1 welds by irradiating a laser 20a toward a workpiece 100 and by melting the portion of the workpiece 100 on which the laser 20a is irradiated. For example, as shown in FIG. 1, the welding can be performed by irradiating the laser 20a on a connection portion of a workpiece 100a and a workpiece 100b. Although not particularly limited, the configuration of the weld may be, for example, a butt weld or a fillet weld. The configuration of the weld illustrated in FIG. 1 is a butt weld.

The welding device 1 can include a torch 10, a laser irradiation part 20, a detector 30, a moving part 40, and a controller 50.

The torch 10 includes, for example, a housing 11, a lens 12, a lens 13, and a half mirror 14.

The housing 11 is tubular and has a shape that extends in one direction. The central axis of the housing 11 can be tilted or substantially perpendicular to the welding surface of the workpiece 100. However, as shown in FIG. 1, when the central axis of the housing 11 is substantially perpendicular to the welding surface of the workpiece 100, a reflected light 20b of the laser 20a irradiated on the workpiece 100 and/or a light emission 20c that is generated at the portion on which the laser 20a is irradiated and includes visible light and/or infrared light can be detected with high accuracy. Also, when the laser 20a is irradiated from a direction substantially perpendicular to the welding surface of the workpiece 100, the workpiece 100 can efficiently absorb the laser 20a.

The lens 12 can be located inside the housing 11. The lens 12 can be located at the end portion of the housing 11 at the side opposite to the workpiece 100 side. The lens 12 condenses the laser 20a irradiated from the laser irradiation part 20.

The lens 13 can be located inside the housing 11. The lens 13 can be located at the end portion of the housing 11 at the workpiece 100 side. The lens 13 further condenses the laser 20a condensed by the lens 12 and irradiates the laser 20a on the workpiece 100. When the laser 20a is irradiated on the workpiece 100, welding is performed by a portion of the irradiated laser 20a being absorbed by the workpiece 100.

A portion of the laser 20a irradiated on the workpiece 100 is reflected and is incident on the lens 13. Therefore, the lens 13 also can condense the reflected light 20b from the workpiece 100. When the laser 20a is irradiated, the portion on which the laser 20a is irradiated melts, high-temperature metal vapor 100d is generated, and the light emission 20c that includes visible light, infrared light, etc., is generated. A portion of the light emission 20c is incident on the lens 13. Therefore, the lens 13 also can condense a light emission 20c1 (a portion of the light emission 20c) that is incident.

The half mirror 14 can be located inside the housing 11. The half mirror 14 can be located between the lens 12 and the lens 13. The half mirror 14 can be tilted with respect to the central axis of the housing 11. The half mirror 14 transmits the laser 20a that is incident from the lens 12 side. The laser 20a that passes through the half mirror 14 is incident on the lens 13. Also, the half mirror 14 reflects the reflected light 20b and the light emission 20c1 that are incident from the lens 13 side. Because the half mirror 14 is tilted with respect to the central axis of the housing 11, the reflected light 20b and the light emission 20c1 that are reflected by the half mirror 14 are emitted to the side of the housing 11.

The laser irradiation part 20 includes, for example, a laser oscillator 21, an irradiation head 22, and a transmitter 23.

The laser oscillator 21 can be, for example, a YAG (Yttrium Aluminum Garnet) laser oscillator. In such a case, the wavelength of the fundamental of the laser 20a emitted from the laser oscillator 21 can be, for example, about 1064 nm.

Also, the laser oscillator 21 can be a pulsed laser oscillator, that is, can provide a pulse oscillation of the laser 20a. In pulse oscillation, the thermal effects on the periphery of the portion on which the laser 20a is irradiated can be small even though the peak power is high because the irradiation time of one pulse is short. Moreover, a high peak power is advantageous for welding a highly reflective material such as aluminum, an aluminum alloy, etc. In such a case, a weld zone 100c of the workpiece 100 can be spot-shaped (pulse spot welding) or line-shaped (pulse seam welding) as shown in FIG. 1.

The irradiation head 22 irradiates the laser 20a emitted from the laser oscillator 21 on the lens 12.

The transmitter 23 is located between the laser oscillator 21 and the irradiation head 22 and transmits the laser 20a emitted from the laser oscillator 21 to the irradiation head 22. The transmitter 23 can be, for example, an optical fiber, etc.

As described above, the laser irradiation part 20 irradiates the laser 20a on the workpiece 100.

As shown in FIG. 1, the detector 30 detects the reflected light 20b and the light emission 20c1 emitted from the housing 11 via the half mirror 14. In other words, the detector 30 detects the reflected light 20b from the portion on which the laser 20a is irradiated and the light emission 20c due to the irradiation of the portion on which the laser 20a is irradiated. In such a case, as described below, the weld state is detected based on the detected value of the reflected light 20b and the detected value of the light emission 20c1. Therefore, the detector 30 can include a sensor 31 that detects the reflected light 20b and a sensor 32 that detects the light emission 20c1.

As described above, the wavelength of the reflected light 20b is the same as the laser 20a because the reflected light 20b is reflected light of the laser 20a. Therefore, the sensor 31 is configured to detect light of the wavelength of the laser 20a, e.g., light of a wavelength of about 1064 nm.

As described above, the light emission 20c1 is light that is generated due to the irradiation of the laser 20a and therefore includes a wide wavelength band including visible light, infrared light, etc. Therefore, the sensor 32 can include at least one of a sensor 32a that is configured to detect visible light or a sensor 32b that is configured to detect infrared light. The visible light can be, for example, light of a wavelength in the range of 300 nm to 800 nm. The infrared light can be, for example, light of a wavelength in the range of 1100 nm to 1600 nm.

The moving part 40 moves the position of the workpiece 100 on which the laser 20a is irradiated. For example, the moving part 40 moves the relative position of the torch 10 and the workpiece 100. As illustrated in FIG. 1, when the moving part 40 moves the position of the workpiece 100, the moving part 40 can be a moving table or the like on which the workpiece 100 can be placed. The moving table can be, for example, a uniaxial table, an XY table, or the like that includes a servo motor, etc. When the moving part 40 moves the position of the torch 10, the moving part 40 can be an articulated robot or the like that is configured to hold the torch 10. The moving part 40 also can be configured to move the position of the torch 10 and the position of the workpiece 100.

The controller 50 controls the operation of the components included in the welding device 1. The controller 50 can include, for example, an arithmetic element such as a CPU (Central Processing Unit) or the like and a memory element such as semiconductor memory, etc. The controller 50 can be, for example, a computer. The memory element can store control programs that control the operations of the components included in the welding device 1. The arithmetic element uses control programs stored in the memory element, data input by an operator, etc., to control the operations of the components included in the welding device 1.

The controller 50 detects the weld state based on a detection signal from the detector 30. The controller 50 detects the weld state of the portion on which the laser 20a is irradiated based on the detected reflected light 20b and the detected light emission 20c1 due to the irradiation. For example, the arithmetic element can detect the weld state based on a determination program stored in the memory element, data such as thresholds or the like, and the detection signal from the detector 30.

Details relating to the detection of the weld state are described below.

Effects of the welding device 1 will now be illustrated.

Although butt welding of the workpieces 100a and 100b illustrated in FIG. 1 will now be described, this is similar also for fillet welding of a workpiece 101a and a workpiece 101b.

First, the workpiece 100a and the workpiece 100b are placed on the moving part 40 by a not-illustrated transfer apparatus, operator, etc.

Then, the controller 50 controls the laser oscillator 21 to repeatedly produce the pulse-form laser 20a at a prescribed interval. The laser 20a that is emitted from the laser oscillator 21 is transmitted to the irradiation head 22 via the transmitter 23 and is irradiated from the irradiation head 22 toward the lens 12. The laser 20a that is incident on the lens 12 is condensed by the lens 12, passes through the half mirror 14, and is incident on the lens 13. The laser 20a that is incident on the lens 13 is condensed by the lens 12 and is irradiated on the connection portion (the welding position) of the workpieces 100a and 100b.

The controller 50 can perform the line-shaped welding described above by controlling the moving part 40 to move the relative position of the torch 10 and the workpiece 100.

For example, to prevent movement of the position of the workpiece 100b with respect to the workpiece 100a, there are also cases where spot-shaped welding of the workpieces 100a and 100b is performed before performing the line-shaped welding, and the line-shaped welding is performed subsequently. In such a case, it is sufficient to produce the pulse-form laser 20a at positions at which spot-shaped welding is performed, and not to produce the pulse-form laser 20a between the positions at which the spot-shaped welding is performed.

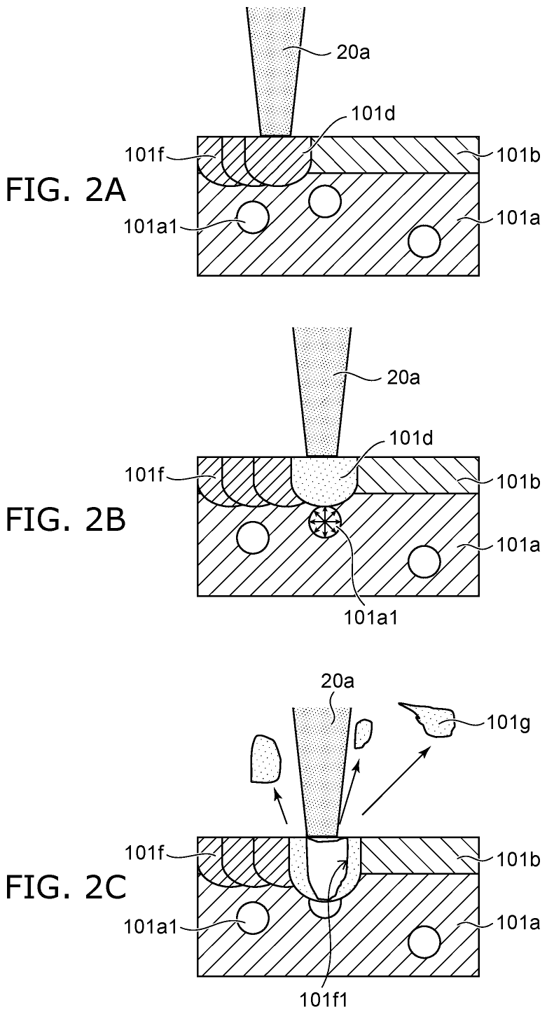

The reflected light 20b and the light emission 20c are generated when the laser 20a is irradiated on the welding position. Although visible light and infrared light are included in the light emission 20c, the visible light is mainly generated in metal vapor. Therefore, the visible light also may be called plasma light emission, etc. The infrared light is mainly generated in a weld pool 101d. The weld pool 101d is described in FIGS. 2A to 2C described below.

The reflected light 20b and the light emission 20c1 (a portion of the light emission 20c) are incident on the detector 30 via the lens 13 and the half mirror 14. A detection signal based on the reflected light 20b and a detection signal based on the light emission 20c1 are output from the detector 30.

The controller 50 can detect the weld state based on the detection signal based on the reflected light 20b and the detection signal based on the light emission 20c1.

Also, the controller 50 can determine the goodness of the weld state based on the detection result of the weld state. Based on the determination result, the controller 50 can repair the defective portion, display information of the defective portion (e.g., the size and/or the position of a recess 101f1 described below, etc.) in a display device, and transmit the information of the defective portion to an external device.

The workpiece 100 (the workpiece 100a and the workpiece 100b) for which a series of tasks is finished is dispatched outside the welding device 1 by a not-illustrated transfer apparatus, operator, etc.

The method for detecting the weld state according to the embodiment will now be described further.

First, a defect that occurs at the portion on which the laser 20a is irradiated will be described.

FIGS. 2A to 2C are schematic cross-sectional views for illustrating the occurrence of the recess 101f1.

Although fillet welding of the workpieces 101a and 101b is described in FIGS. 2A to 2C, this is also similar for butt welding of the workpieces 100a and 100b illustrated in FIG. 1.

As shown in FIG. 2A, there are cases where a heterogeneous portion 101a1 is inside the workpiece 101a. For example, when the workpiece 101a is a casting material of aluminum, magnesium, etc., an inclusion that has a low boiling point, a resin that is easily gasified at a low temperature, etc., may be included. When the weld pool 101d reaches the portion 101a1 as shown in FIG. 2B, the portion 101a1 expands all at once. The weld pool 101d is formed from molten metal. Therefore, when the portion 101a1 expands as shown in FIG. 2C, sputtering occurs in which molten metal 101g scatters. The recess 101f1 occurs in a weld zone 101f when the molten metal 101g scatters. When the recess 101f1 occurs, the product value degrades because the appearance degrades. Also, according to the application of the welded workpiece (e.g., when applied to a sealed container), the recess 101f1 causes leakage of a liquid or a gas.

Therefore, according to the method for detecting the weld state according to the embodiment, the occurrence of the recess 101f1 is detected, and information of the size, the configuration, etc., of the recess 101f1 that occurs is acquired.

First, the detection of the occurrence of the recess 101f1 will be described.

When the recess 101f1 occurs, specular reflection of the laser 20a is obstructed; therefore, the signal level from the sensor 31 that detects the reflected light 20b decreases. Therefore, by using a prescribed threshold, etc., to monitor the signal level from the sensor 31, the occurrence of the recess 101f1 can be detected.

When the molten metal 101g scatters, the intensity of the visible light and/or the infrared light abruptly increases. For example, the occurrence of the recess 101f1 can be detected by using a prescribed threshold, etc., to monitor at least one of the signal level from the sensor 32a detecting visible light or the signal level from the sensor 32b detecting infrared light.

Here, the signal level from the sensor 31 detecting the reflected light 20b is affected by the surface state of the workpiece before welding, etc. For example, the signal level from the sensor 31 decreases when there is already a recess in the surface of the workpiece before welding.

In such a case, the signal level from the sensor 32a detecting visible light and the signal level from the sensor 32b detecting infrared light are not easily affected by the surface state of the workpiece before welding, etc. Therefore, the signal level from the sensor 32a and the signal level from the sensor 32b are useful for detecting the occurrence of the recess 101f1.

Therefore, according to the method for detecting the weld state according to the embodiment, the occurrence of the recess 101f1 that occurs due to the scattering of the molten metal 101g is detected using the signal level from the sensor 31 detecting the reflected light 20b and at least one of the signal level from the sensor 32a detecting visible light or the signal level from the sensor 32b detecting infrared light.

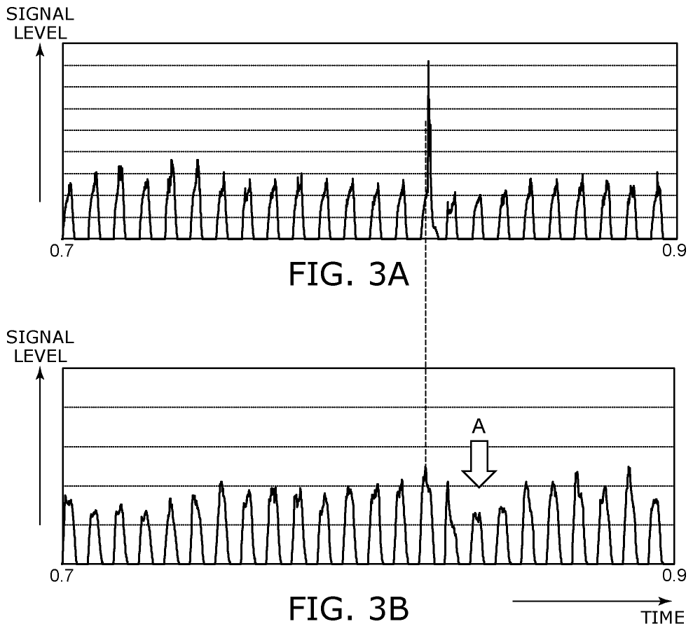

FIG. 3A is a graph for illustrating the change of the signal level from the sensor 32a detecting visible light.

Although the change of the signal level from the sensor 32a is used as an example in FIG. 3A, the visible light and the infrared light are emitted due to the irradiation of the laser 20a; therefore, the signal level from the sensor 32b detecting infrared light also similarly changes. Therefore, the change of the signal level from the sensor 32b also can be used. The signal level from the sensor 32a and the signal level from the sensor 32b also can be used. In other words, it is sufficient to know the change of the intensity of the light emission 20c due to the irradiation of the laser 20a.

FIG. 3B is a graph for illustrating the change of the signal level from the sensor 31 detecting the reflected light 20b.

As described above, the pulse-form laser 20a is repeatedly produced to perform line-shaped welding. The reflected light 20b and the light emission 20c due to the irradiation are generated substantially simultaneously with the irradiation of the laser 20a of one pulse. However, although the intensity of the light emission 20c due to the irradiation quickly increases when the molten metal 101g scatters, the recess 101f1 is formed after the molten metal 101g scatters; therefore, the signal level of the reflected light 20b decreases after a slight delay. For example, the occurrence of the recess 101f1 can be detected using the signal level of FIG. 3A at some time and the signal level of FIG. 3B at a slightly delayed time.

The occurrence of the recess 101f1 can be detected using at least one of the increase of the signal level from the sensor 32a detecting the visible light or the increase of the signal level from the sensor 32b detecting infrared light. However, the detection accuracy can be further improved by also using the decrease of the signal level from the sensor 31 detecting the reflected light 20b.

Information of the size, the configuration, etc., of the recess 101f1 that occurs will now be described.

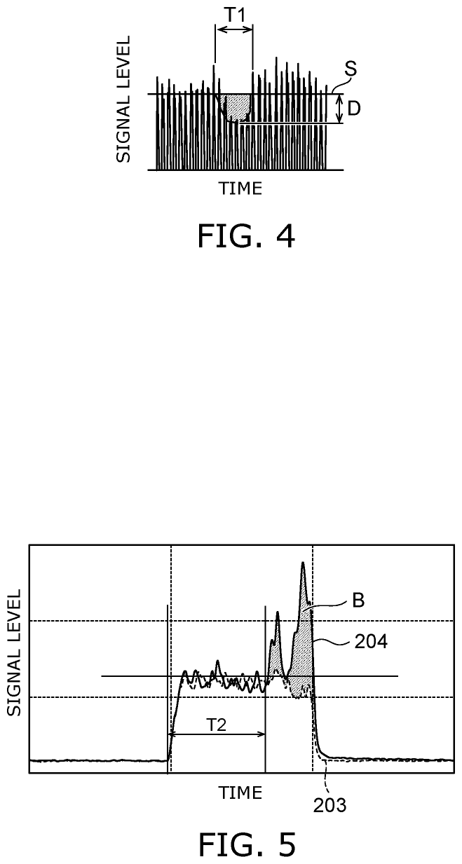

FIG. 4 is an enlarged view of portion A of FIG. 3B.

As described above, the signal level from the sensor 31 detecting the reflected light 20b is affected by the size, the configuration, etc., of the recess 101f1. Therefore, information of the size, the configuration, etc., of the recess 101f1 is included in the signal from the sensor 31.

As shown in FIG. 4, a time T1 during which the signal level of the reflected light 20b is not more than a prescribed threshold S can be determined, and an approximate value of the length (the opening dimension) of the recess 101f1 can be determined from the product of the time T1 and the movement speed due to the moving part 40. There is a correlation between the signal level and the reflection position; therefore, an approximate value of a depth D of the recess 101f1 can be determined from the difference between the prescribed threshold S and the minimum value of the signal level.

The correlation that the threshold S has with the signal level and the reflection position can be predetermined by performing experiments and/or simulations. Also, the average value of the signal level can be successively determined over a prescribed period; and the determined average value can be used as the threshold S. Thus, the average value of the signal level at the periphery of the recess 101f1 can be used as the threshold S; therefore, the length of the recess 101f1 and the calculation accuracy of the depth D can be increased.

As described above, the information of the size, the configuration, etc., of the recess 101f1 can be obtained by using the signal level from the sensor 31 detecting the reflected light 20b.

FIG. 5 is a graph for illustrating the change of a signal level of visible light corresponding to the irradiation of one pulse of the laser 20a.

As described above, the visible light and the infrared light are generated by the irradiation of the laser 20a; therefore, the signal level of the infrared light also changes similarly. Therefore, the change of the signal level of the infrared light also can be used.

In FIG. 5, a waveform 203 is when the recess 101f1 does not occur, and a waveform 204 is when the recess 101f1 occurs.

A difference B between the integral of the waveform 204 and the integral of the waveform 203 has a correlation with the volume of the scattered molten metal. An approximate value of the size (the volume) of the recess 101f1 can be determined from the integral difference B and the correlation between the volume of the scattered molten metal and the integral difference. The correlation between the volume of the scattered molten metal and the integral difference can be predetermined by performing experiments and/or simulations.

It is considered that the timing at which the signal level starts to increase is the time at which the molten metal scatters. An approximate value of the depth at the timing at which the molten metal scatters can be determined by determining a time T2 between the input start timing of the signal and the timing at which the signal level starts to increase. It is considered that in such a case, if the time T2 is short, the depth is shallow at the timing at which the molten metal scatters, and a shallow recess 101f1 has occurred. It is considered that if the time T2 is long, the depth is deep at the timing at which the molten metal scatters, and a deep recess 101f1 has occurred. The correlation between the time T2 and the depth can be predetermined by performing experiments and/or simulations.

As described above, the information of the size, the configuration, etc., of the recess 101f1 can be obtained by using at least one of the signal level from the sensor 32a detecting the visible light or the signal level from the sensor 32b detecting the infrared light.

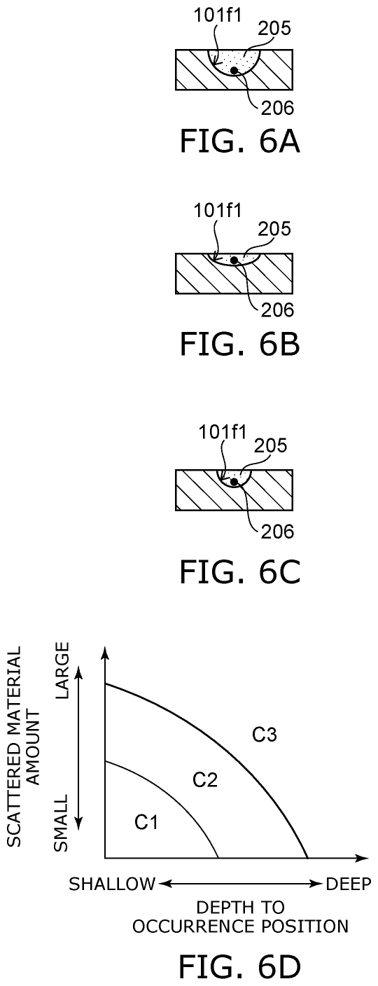

FIGS. 6A to 6D are schematic views for illustrating a determination of the recess 101f1.

For example, it is considered that a large recess 101f1 occurs as shown in FIG. 6A as an amount 205 of the scattered material increases and as the depth to an occurrence position 206 of the scattering increases.

For example, it is considered that even if the amount 205 of the scattered material is large, a small recess 101f1 occurs as shown in FIG. 6B as long as the depth to the occurrence position 206 of the scattering is shallow.

For example, it is considered that even if the depth to the occurrence position 206 of the scattering is deep, a small recess 101f1 occurs as shown in FIG. 6C as long as the amount 205 of the scattered material is small.

Considering the amount 205 of the scattered material and the occurrence position 206 of the scattering, for example, the determination of the recess 101f1 can be performed as shown in FIG. 6D.

For example, the size of the recess 101f1 can be determined to be non-defective for a region C1 of FIG. 6D because it is considered that the size of the recess 101f1 is small.

For example, the size of the recess 101f1 can be determined to be a size that is repairable by remelting for a region C2 of FIG. 6D.

For example, the size of the recess 101f1 can be determined to be a size that is nonrepairable by remelting in a region C3 of FIG. 6D.

Here, although the workpiece described above is formed from a metal such as aluminum, copper, etc., there are cases where a member that is formed from a different material from the workpiece is located at the vicinity of the welding position of the workpiece. For example, there are cases where a film that includes a different material from the workpiece such as a metal, an organic material such as a resin or the like, an inorganic material such as a ceramic, etc., is formed at the vicinity of the welding position of the workpiece.

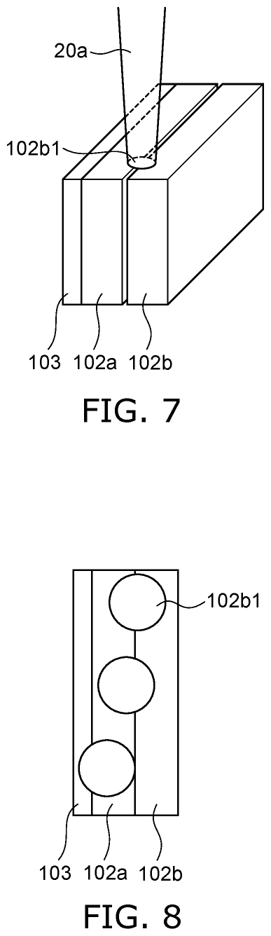

FIG. 7 is a schematic perspective view for illustrating a film located at the vicinity of the welding position of the workpiece.

FIG. 7 is when a plate-shaped workpiece 102a and a plate-shaped workpiece 102b are welded by laser welding. In such a case, for example, the workpiece 102a and the workpiece 102b are formed from aluminum, copper, etc.

Also, a film 103 is formed at a major surface of the workpiece 102a at which a recess 102a1 of the workpiece 102a has an opening. The film 103 can be a coating that includes a different material from the workpiece, e.g., a resin.

FIG. 8 is a schematic plan view for illustrating a welding position 102b1.

FIG. 8 is when the spot-shaped welding described above is performed.

As shown in FIG. 8, the welding is performed along the boundary between the workpiece 102a and the workpiece 102b. In such a case, the welding position 102b1 is taken to be a position at which the laser 20a is not irradiated on the film 103.

However, when the width of the workpiece 102a is small, etc., there may be cases where the laser 20a is irradiated on the film 103. When the laser 20a is irradiated on the film 103, there is a risk that the film 103 may be damaged, and the product value of the product may be drastically reduced.

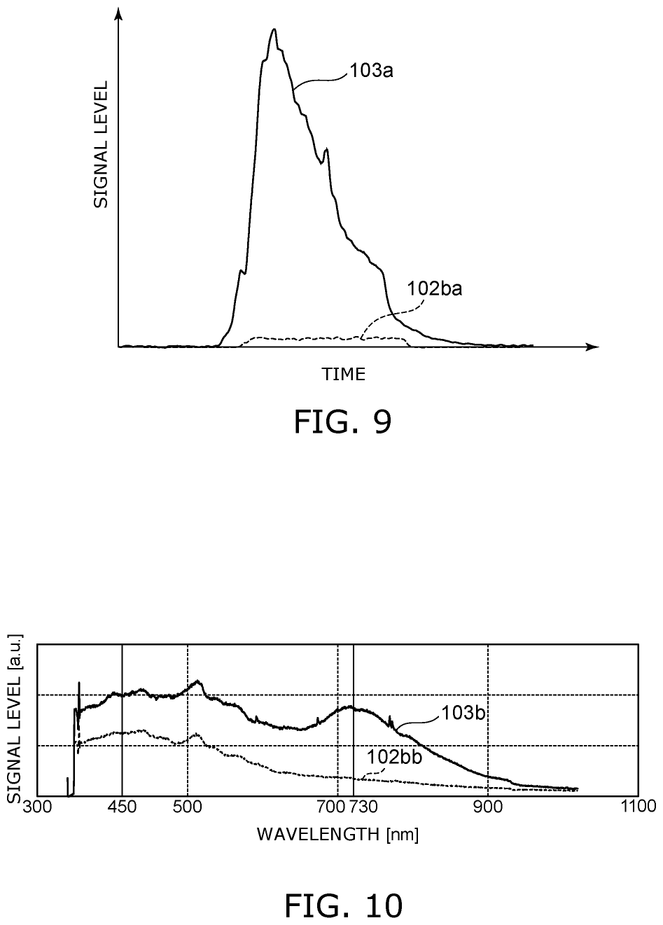

FIG. 9 is a graph for illustrating the change of a signal level of visible light corresponding to the irradiation of one pulse of the laser 20a.

In FIG. 9, a waveform 102ba is when the laser 20a is irradiated only on the workpieces 102a and 102b that include an aluminum alloy.

In FIG. 9, a waveform 103a is when the laser 20a is irradiated only on the film 103 that includes a resin.

It can be seen from FIG. 9 that when the laser 20a is irradiated on the film 103, for example, the peak level of the visible light greatly increases. Therefore, for example, by using a prescribed threshold, etc., to monitor the signal level from the sensor 32a detecting visible light, the irradiation of the laser 20a on an unintended member such as the film 103, etc., can be known.

In such a case, for example, a display device can display that the laser 20a has been irradiated on an unintended member such as the film 103, etc., together with the determination result of the weld state described above. Also, the position information of the portion at which the unintended irradiation is performed, etc., can be displayed in the display device and can be transmitted to an external device.

Although a case where visible light is used is illustrated as an example, the signal level due to the material changes also for infrared light and the reflected light 20b. Therefore, it is sufficient to use a prescribed threshold, etc., to monitor the signal level from at least one of the sensor 31 detecting the reflected light 20b, the sensor 32a detecting visible light, or the sensor 32b detecting infrared light.

FIG. 10 is a graph for illustrating spectra of the light emission 20c1 corresponding to the irradiation of one pulse of the laser 20a.

Because the light emission 20c1 is light that is generated due to the irradiation of the laser 20a, the light emission 20c1 includes a wide wavelength band including visible light, infrared light, etc.

In FIG. 10, a waveform 102bb is when the laser 20a is irradiated only on the workpieces 102a and 102b that include an aluminum alloy.

In FIG. 10, a waveform 103b is when the laser 20a is irradiated only on the film 103 that includes a resin.

It can be seen from FIG. 10 that the spectrum is different between when the laser 20a is irradiated on the workpieces 102a and 102b and when irradiated on the film 103. In such a case, it can be known that the laser 20a is irradiated on an unintended member such as the film 103, etc., by using a spectrometer or the like because the spectrum difference is known. However, the configuration of such a welding device 1 is complex.

Therefore, in the welding device 1 according to the embodiment, the irradiation of the laser 20a on an unintended member such as the film 103, etc., is detected by using a prescribed threshold, etc., to monitor the signal level from at least one of the sensor 32a detecting visible light or the sensor 32b detecting infrared light.

For example, as shown in FIG. 10, it is sufficient to use a prescribed threshold, etc., to monitor the signal level from at least one of the sensor 32a detecting visible light of a wavelength of 450 nm or the sensor 32b detecting infrared light of a wavelength of 730 nm.

In such a case, for example, the irradiation of the laser 20a on an unintended member such as the film 103, etc., can be displayed in a display device together with the determination result of the weld state described above. Also, the position information of the portion at which the unintended irradiation is performed, etc., can be displayed in the display device and transmitted to an external device.

As described above, the method for detecting the weld state according to the embodiment can include the following processes. The content of the processes can be similar to that described above, and a detailed description is therefore omitted. The following first to fourth thresholds can be pre-appropriately determined by performing experiments and/or simulations.

The processes include:

a process of detecting the reflected light 20b from the portion on which the laser 20a is irradiated and the light emission 20c of the portion on which the laser 20a is irradiated; and

a process of detecting the weld state of the portion on which the laser 20a is irradiated based on the detected reflected light 20b and the detected light emission 20c, wherein

the process of detecting the weld state includes detecting whether or not the signal level of the light emission 20c is not less than a prescribed first threshold and whether or not the signal level of the reflected light 20b is not more than a prescribed second threshold.

The process of detecting the weld state includes determining that the recess 101f1 has occurred at the portion on which the laser 20a is irradiated when the signal level of the light emission 20c is not less than the prescribed first threshold and the signal level of the reflected light 20b is not more than the prescribed second threshold.

The process of detecting the weld state includes calculating the length of the recess 101f1 from the product of the movement speed of the portion on which the laser 20a is irradiated and the time T1 during which the signal level of the reflected light 20b is not more than the second threshold.

The process of detecting the weld state includes calculating the depth of the recess 101f1 from the difference between the second threshold and the minimum value of the signal level.

The process of detecting the weld state includes calculating the size of the recess 101f1 based on the difference between the integral of the signal level of the light emission 20c when a predetermined recess 101f1 has not occurred and the integral of the signal level of the light emission 20c when the predetermined recess 101f1 has occurred.

The process of detecting the weld state includes calculating the depth of the recess 101f1 based on the time T2 between the input start timing of the signal of the light emission 20c and the timing at which the signal level starts to increase.

The process of detecting the weld state includes determining that the laser 20a is irradiated on an unintended portion when the signal level of the reflected light 20b is not less than a prescribed third threshold.

The process of detecting the weld state includes determining that the laser 20a is irradiated on an unintended portion when the signal level of the light emission 20c is not less than a prescribed fourth threshold.

The method for detecting the weld state described above also can be performed in the welding device 1 described above.

For example, the controller 50 detects whether or not the signal level of the light emission 20c1 is not less than the prescribed first threshold and whether or not the signal level of the reflected light 20b is not more than the prescribed second threshold.

The controller 50 determines that the recess 101f1 has occurred at the portion on which the laser 20a is irradiated when the signal level of the light emission 20c1 is not less than the prescribed first threshold and the signal level of the reflected light 20b is not more than the prescribed second threshold.

The controller 50 calculates the length of the recess 101f1 from the product of the movement speed of the portion on which the laser is irradiated and the time T1 during which the signal level of the reflected light 20b is not more than the second threshold.

The controller 50 calculates the depth of the recess 101f1 from the difference between the second threshold and the minimum value of the signal level.

The controller 50 calculates the size of the recess 101f1 based on the difference between the integral of the signal level of the light emission 20c1 when a predetermined recess 101f1 has not occurred and the integral of the signal level of the light emission 20c1 when the predetermined recess 101f1 has occurred.

The controller 50 calculates the depth of the recess 101f1 based on the time T2 between the input start timing of the signal of the light emission 20c1 and the timing at which the signal level starts to increase.

The controller 50 determines that the laser 20a is irradiated on an unintended portion when the signal level of the reflected light 20b is not less than the prescribed third threshold.

The controller 50 determines that the laser 20a is irradiated on an unintended portion when the signal level of the light emission 20c1 is not less than the prescribed fourth threshold.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions. Moreover, above-mentioned embodiments can be combined mutually and can be carried out.

What is claimed is:

1. A method for detecting a weld state, the method comprising:
detecting a reflected light and a light emission, the reflected light being from a portion on which a laser is irradiated, the light emission being of the portion on which the laser is irradiated; and
detecting, based on the detected reflected light and the detected light emission, a weld state of the portion on which the laser is irradiated,
the detecting of the weld state includes detecting whether or not a signal level of the light emission is not less than a first threshold and whether or not a signal level of the reflected light is not more than a second threshold,
the first and second thresholds being prescribed.

2. The method according to claim 1, wherein
the detecting of the weld state includes determining that a recess has occurred at the portion on which the laser is irradiated when the signal level of the light emission is not less than the prescribed first threshold and the signal level of the reflected light is not more than the prescribed second threshold.

3. The method according to claim 2, wherein
the detecting of the weld state includes calculating a length of the recess from a product of a movement speed of the portion on which the laser is irradiated and a time during which the signal level of the reflected light is not more than the second threshold.

4. The method according to claim 2, wherein
the detecting of the weld state includes calculating a depth of the recess from a difference between the second threshold and a minimum value of the signal level.

5. The method according to claim 2, wherein
the detecting of the weld state includes calculating a size of the recess based on a difference between an integral of the signal level of the light emission when a predetermined recess has not occurred and an integral of the signal level of the light emission when the predetermined recess has occurred.

6. The method according to claim 2, wherein
the detecting of the weld state includes calculating a depth of the recess based on a time between an input start timing of the signal of the light emission and a timing of the signal level starting to increase.

7. The method according to claim 1, wherein
the detecting of the weld state includes determining that the laser is irradiated on an unintended portion when the signal level of the reflected light is not less than a third threshold, and
the third threshold is prescribed.

8. The method according to claim 1, wherein
the detecting of the weld state includes determining that the laser is irradiated on an unintended portion when the signal level of the light emission is not less than a fourth threshold, and
the fourth threshold is prescribed.

9. The method according to claim 1, wherein
the signal level of the light emission is at least one of a signal level of visible light or a signal level of infrared light.

10. The method according to claim 1, further comprising:
repairing the portion on which the laser is irradiated based on the weld state detected in the detecting of the weld state.

11. A welding device, comprising:
a laser irradiation part configured to irradiate a laser on a workpiece;
a detector configured to detect a reflected light and a light emission, the reflected light being from a portion on which the laser is irradiated, the light emission being of the portion on which the laser is irradiated; and
a controller configured to detect, based on the detected reflected light and the detected light emission, a weld state of the portion on which the laser is irradiated,
the controller detecting whether or not a signal level of the light emission is not less than a first threshold and whether or not a signal level of the reflected light is not more than a second threshold,
the first and second thresholds being prescribed.

12. The device according to claim 11, wherein
the controller determines that a recess has occurred at the portion on which the laser is irradiated when the signal level of the light emission is not less than the prescribed first threshold and the signal level of the reflected light is not more than the prescribed second threshold.

13. The device according to claim 12, further comprising:
a moving part configured to move a position of the workpiece on which the laser is irradiated,
the controller calculating a length of the recess from a product of a movement speed of the portion on which the laser is irradiated and a time during which the signal level of the reflected light is not more than the second threshold.

14. The device according to claim 12, wherein
the controller calculates a depth of the recess from a difference between the second threshold and a minimum value of the signal level.

15. The device according to claim 12, wherein
the controller calculates a size of the recess based on a difference between an integral of the signal level of the light emission when a predetermined recess has not occurred and an integral of the signal level of the light emission when the predetermined recess has occurred.

16. The device according to claim 12, wherein
the controller calculates a depth of the recess based on a time between an input start timing of the signal of the light emission and a timing of the signal level starting to increase.

17. The device according to claim 11, wherein
the controller determines that the laser is irradiated on an unintended portion when the signal level of the reflected light is not less than a third threshold, and
the third threshold is prescribed.

18. The device according to claim 11, wherein
the controller determines that the laser is irradiated on an unintended portion when the signal level of the light emission is not less than a fourth threshold, and
the fourth threshold is prescribed.

19. The device according to claim 11, wherein
the detector configured to detect the light emission of the portion on which the laser is irradiated is configured to detect at least one of visible light or infrared light.

20. The method according to claim 11, wherein
the controller repairs the portion on which the laser is irradiated based on the detected weld state.
